(19) United States
(12) Patent Application Publication
(10) Pub. No.: US 2026/0133799 A1
(43) Pub. Date: May 14, 2026

(54) SYSTEM AND METHOD FOR ARTIFICIAL INTELLIGENCE ACCELERATOR

(71) Applicant: TAIWAN SEMICONDUCTOR MANUFACTURING COMPANY, LTD., Hsinchu (TW)

(72) Inventors: Ashwin Sanjay LELE, San Jose, CA (US); Win-San KHWA, Taipei City (TW); Brian CRAFTON, San Jose, CA (US); Bo ZHANG, San Jose, CA (US); Meng-Fan CHANG, Taichung City (TW)

(73) Assignee: TAIWAN SEMICONDUCTOR MANUFACTURING COMPANY, LTD., Hsinchu (TW)

(21) Appl. No.: 18/943,637

(22) Filed: Nov. 11, 2024

(51) Int. Cl. G06F 9/30

(52) U.S. Cl. CPC G06F 9/30047

(57) ABSTRACT

A system comprising a global memory and multiple core circuits is provided. The global memory stores data of a machine learning model. The core circuits are coupled to the global memory, in which each of the core circuits comprises an instruction buffer, a compute-in-memory (CIM) circuit and a controller. The instruction buffer stores a first instruction including portions corresponding to different fields. The CIM circuit configured to perform CIM operations according to a first portion of the portions. The controller is coupled between the instruction buffer and the CIM circuit, in which the controller operates according to a second portion of the portions. The CIM circuit and the controller cooperate to perform operations of the machine learning model.

### BACKGROUND

For an artificial intelligence (AI) accelerator, the workloads evolve rapidly. For example, the compute-in-memory (CIM) macro in the AI accelerator may update for different technologies like resistive random access memory (RRAM), magnetoresistive random access memory (MRAM), etc. To achieve quick prototyping to test application-level performance of the AI accelerator, the controller within the AI accelerator needs to seamlessly support the updates and new circuit configurations (e.g., different datatype).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system in accordance with various embodiments of the present disclosure.

FIG. 2 is a schematic diagram of an example of the cores of the system in FIG. 1, in accordance with various embodiments of the present disclosure.

FIG. 3 depicts an example of transfer of the instruction between decoders and the instruction buffer in the core of the system of FIGS. 1-2, in accordance with various embodiments of the present disclosure.

FIG. 4 is a schematic diagram of an example of a core configured with respect to the core corresponding to FIGS. 1-3, in accordance with various embodiments of the present disclosure.

FIG. 5 is a schematic diagram of an example of a core configured with respect to the cores corresponding to FIGS. 1-4, in accordance with various embodiments of the present disclosure.

FIG. 6 is a schematic diagram of an example of the global memory, local memory and the ALU of the cores corresponding to FIGS. 1-5, in accordance with various embodiments of the present disclosure.

FIG. 7 is a schematic diagram of an example of a refresh circuit of the system corresponding to FIGS. 1-6, in accordance with various embodiments of the present disclosure.

FIG. 8 is a flowchart diagram of a method for operating the system, cores corresponding to FIGS. 1-7, in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

As used herein, “around”, “about”, “approximately” or “substantially” shall generally refer to any approximate value of a given value or range, in which it is varied depending on various arts in which it pertains, and the scope of which should be accorded with the broadest interpretation understood by the person skilled in the art to which it pertains, so as to encompass all such modifications and similar structures. In some embodiments, it shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

This application relates to a system of artificial intelligence (AI) accelerator. The system has a very large instruction word (VLIW) based instruction set architecture (ISA). The VLIW based ISA supports updating certain configurations of the system without changing other portions of the system which benefits rapid prototyping of system on a chip (SoC) of the AI accelerator.

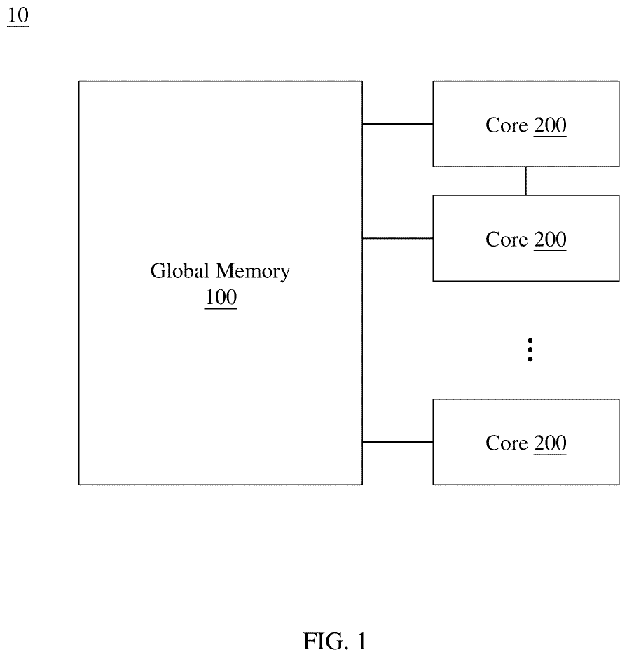

Reference is now made to FIG. 1. FIG. 1 is a schematic diagram of a system 10 in accordance with various embodiments of the present disclosure. In some embodiments, the system 10 is an AI accelerator system. In some embodiments, the system 10 is a CIM system. For illustration, the system 10 includes a global memory (GM) 100 and multiple cores 200. The global memory is coupled to the cores 200. According to various embodiments, the memory 100 may be a static random-access memory (SRAM), resistive random-access memory (RRAM), gain cell memory, any other suitable memories, or combination thereof.

In some embodiments, the global memory 100 and the cores 200 cooperate to perform operations of a machine learning model (e.g., an inference of a neural network). The global memory 100 stores data of the machine learning model (e.g., weights, features, outputs, instructions, etc.) The cores 200 receive the data from the global memory 100 and perform computations of the machine learning model. The cores 200 output computation results (e.g., the outputs of the machine learning model) to the global memory 100.

For practical applications, the machine learning model of the system 10 may be utilized in various fields such as machine vision, image classification, or data classification. For example, the machine learning model may be used for classifying medical images. For example, it can be used to classify X-ray images in normal conditions, with pneumonia, with bronchitis, or with heart disease. The machine learning model may also be used to classify ultrasound images with normal fetuses or abnormal fetal positions. On the other hand, the machine learning model can also be used to classify images collected in automatic driving, such as distinguishing normal roads, roads with obstacles, and road conditions images of other vehicles. Furthermore, the machine learning model can be utilized in other similar fields, such like music spectrum recognition, spectral recognition, big data analysis, data feature recognition and other related machine learning fields.

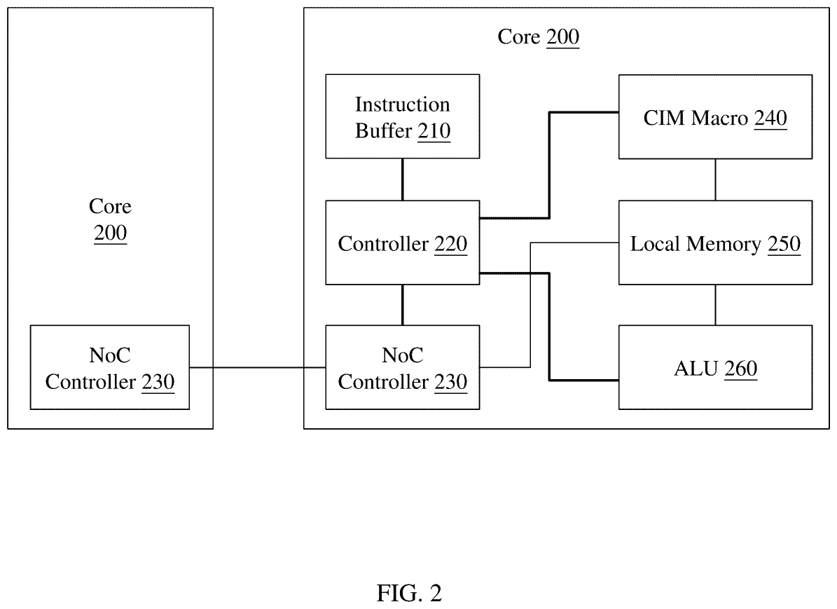

Reference is now made to FIG. 2. FIG. 2 is a schematic diagram of an example of the cores 200 of the system 10 in FIG. 1, in accordance with various embodiments of the present disclosure. With respect to the embodiments of FIG. 1, like elements in FIG. 2 are designated with the same reference numbers for ease of understanding. The specific operations of similar elements, which are already discussed in detail in previous paragraphs, are omitted for the sake of brevity.

For illustration, the core 200 includes an instruction buffer 210, a local memory (LM) 250 and function circuits including a controller 220, a network-on-chip (NoC) controller 230, a CIM macro 240, and an arithmetic logic unit (ALU) 260. The instruction buffer 210 is coupled to the controller 220. The controller 220 is coupled to the NoC controller 230, the CIM macro 240, the local memory 250 and the ALU 260. The NoC controller 230 is coupled to the local memory 250. The CIM macro 240 is coupled to the local memory 250. The local memory 250 is coupled to the ALU 260. As shown in FIG. 1, the core 200 is coupled to adjacent cores 200 through the NoC controller 230. For example, the NoC controllers 230 of two neighboring cores are coupled to each other.

In application, the instruction buffer 210 stores instructions scheduled to be executed within the core 200. In some embodiments, the instructions indicate operations of the machine learning model.

The controller 220 read an instruction from the instruction buffer 210 to trigger (control) different function units (i.e., NoC controller 230, CIM macro 240 and ALU 260) within the core 200 according to the instructions. In some embodiments, the controller 220, the NoC controller 230, the CIM macro 240 and the ALU 260 cooperate to perform computations of the machine learning model according to the instructions.

In some embodiments, the controller 220 sends control information to the NoC controller 230, the CIM macro 240 and the ALU 260. In some embodiments, the controller 220 also receives control information from the NoC controller 230, the CIM macro 240 and the ALU 260. The controller 220 commands the function units within the core 200 through the control information transferred between the function units.

According to various embodiments, the controller 220 may be a central processing unit (CPU), or other general-purpose or special-purpose processor, a microprocessor, a digital signal processor (DSP), a programmable controller, an application-specific integrated circuit (ASIC), a complex programmable logic device (CPLD), a field-programmable gate array (FPGA), or other similar components or a combination of the above components.

The CIM Macro 240 is a circuit performing CIM operations, for example, multiply-and-accumulate (MAC) operations, matrix-multiplication operations, and/or other structured arithmetic operations. In some embodiments, the CIM Macro 240 includes a CIM memory array, adders and accumulators, etc. In some embodiments, the CIM Macro 240 generates activations and/or partial sums corresponding to different computation nodes of the machine learning model.

The ALU 260 is a circuit for data processing. In some embodiments, the ALU 260 includes a scalar processing circuit and a vector processing circuit for pre/post processing of the activations and/or partial sums from the CIM Macro 240. For example, the ALU 260 performs operations like norm and softmax to the activations and/or partial sums.

The local memory 250 is configured for local storage of the cores 200. For example, the local memory 250 stores the partial sums generated by the CIM macro 240. The ALU 260 receives the partial sums from the local memory 250 and performs data processing to the partial sums. Then, the ALU 260 sends the processed partial sums (e.g., softmax result) to the local memory 250 for storage. According to various embodiments, the local memory 250 may be a SRAM, synthesized register files, etc. In some embodiments, the NoC controller 230, the CIM macro 240 and the ALU 260 transfer data through the local memory 250.

In some embodiments, the NoC controller 230 performs on-chip communication of the system 10. For example, the NoC controller 230 sends data from the local memory 250 to an adjacent NoC controller 230 of an adjacent core 200. In some embodiments, the NoC controller 230 receives data from the adjacent NoC controller 230 of the adjacent core 200 and sends the data to the local memory 250 for storage.

In some embodiment, the NoC controller 230 is coupled to the global memory 100 to perform data transfer between the local memory 250 and the global memory 100.

In some embodiments, the system 10 supports the VLIW ISA to separate the instruction into fields. In some embodiments, the instruction is separated into fields of control operation, NoC operation, CIM operation and ALU operation corresponding to the controller 220, the NoC controller 230, the CIM macro 240 and the ALU 260 respectively.

With this configuration, rapidly evolving hardware related fields (e.g., CIM macro field and/or ALU field) are separated from other fields. While instruction design corresponding to one field is updated, the ISA, microarchitecture and register-transfer level (RTL) implementation corresponding to other fields can stay the same.

For example, the machine learning model of the system 10 may change from convolutional neural network to transformer. The hardware configurations of the CIM macro 240 may change accordingly. In addition, the activation function performed by the ALU 260 may change (e.g., from ReLu to SiLu or softmax). With the VLIW ISA, the system 10 can update the configurations of fields corresponding to the change without modifying the other fields.

In addition, in each cycle when the instruction buffer 210 outputs an instruction, the operations (e.g., control operation, NoC operation, CIM operation and ALU operation) corresponding to the different fields can be performed within the same cycle.

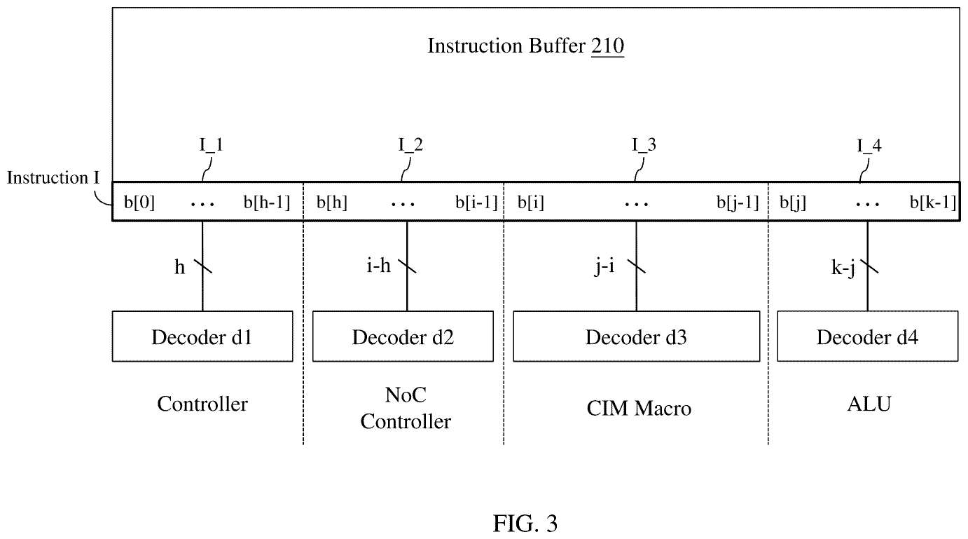

In some embodiments, the instruction with different fields is decoded by different decoders to command the function circuits to perform operations corresponding to the different fields in the same cycle as described in the following paragraphs with reference to FIGS. 3-5.

Reference is now made to FIG. 3. FIG. 3 depicts an example of transfer of the instruction between decoders d1-d4 and the instruction buffer 210 in the core 200 of the system 10 of FIGS. 1-2, in accordance with various embodiments of the present disclosure. With respect to the embodiments of FIGS. 1-2, like elements in FIG. 3 are designated with the same reference numbers for ease of understanding.

The instruction buffer 210 stores at least one instruction. For example, each row of the instruction buffer 210 stores an instruction. The instruction buffer 210 outputs the stored instructions one after another.

Each instruction is separated into different portions corresponding to different fields. For example, as shown in FIG. 3, when an instruction I is output, the instruction I is sliced into four portions I_1, I_2, I_3 and I_4 and transferred to decoders d1-d4 that correspond to fields of the controller 220, the NoC controller 230, the CIM macro 240 and the ALU 260 respectively.

Specifically, in some embodiments, the portion I_1 includes the first bit b[0] to the “h”th bit b[h−1] of the instruction I corresponding to the decoder d1 of the field of the controller 220. The portion I_2 includes the “h+1”th bit b[h] to the “i”th bit b[i−1] of the instruction I corresponding to the decoder d2 of the field of the NoC controller 230. The portion I_3 includes the “i+1”th bit b[i] to the “j”th bit b[j−1] of the instruction I corresponding to the decoder d3 of the field of the CIM macro 240. The portion I_4 includes the “j+1”th bit b[j] to the “k”th bit b[k−1] of the instruction I corresponding to the decoder d4 of the field of the ALU 260. The “h”, “i”, “j” and “k” denote different integers and the relationship thereof is “k>j>i>h”.

In some embodiments, the bits of the instruction are transferred from the instruction buffer 210 to the decoders simultaneously through multiple metal lines in a clock cycle. For example, the bits b[0]-b[k−1] are transmitted to the decoders d1-d4 in parallel.

Specifically, the bits b[0]-b[h−1] are transmitted to the decoder d1 through “h” metal lines coupled between the instruction buffer 210 and the decoder d1. The bits b[h]-b[i−1] are transmitted to the decoder d2 through “i−h” metal lines coupled between the instruction buffer 210 and the decoder d2. The bits b[i]-b[j−1] are transmitted to the decoder d3 through “j−i” metal lines coupled between the instruction buffer 210 and the decoder d3. The bits b[j]−b[k−1] are transmitted to the decoder d4 through “k−j” metal lines coupled between the instruction buffer 210 and the decoder d4.

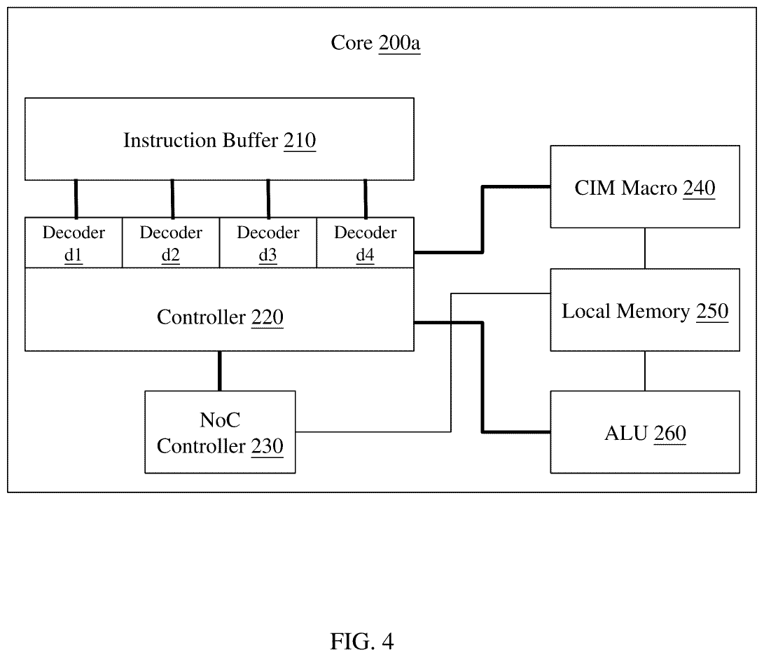

Reference is now made to FIG. 4. FIG. 4 is a schematic diagram of an example of a core 200a configured with respect to the core 200 corresponding to FIGS. 1-3, in accordance with various embodiments of the present disclosure. With respect to the embodiments of FIGS. 1-3, like elements in FIG. 4 are designated with the same reference numbers for ease of understanding.

As shown in FIG. 2, in the core 200a in FIG. 4, the decoders d1-d4 are coupled in parallel between the instruction buffer 210 and the controller 220. The decoders d1-d4 decode the portions I_1, I-2, I-3 and I_4 to generate a decoded controller instruction, a decoded NoC controller instruction, a decoded CIM macro instruction and a decoded ALU instruction.

In some embodiments, the controller 220 sends the decoded NoC controller instruction, the decoded CIM macro instruction and the decoded ALU instruction to the NoC controller 230, the CIM macro 240 and the ALU 260 respectively. Then, the NoC controller 230, the CIM macro 240 and the ALU 260 perform operations according to the decoded NoC controller instruction, the decoded CIM macro instruction and the decoded ALU instruction respectively.

For example, in the same cycle, the controller 220 assigns value to a variable according to the decoded controller instruction. The NoC controller 230 loads data from the global memory 100 to the local memory 250 according to the decoded NoC controller instruction. The CIM macro 240 performs a vector multiplication according to the decoded CIM macro instruction. The ALU 260 performs an exponential operation to data in the local memory 250 according to the decoded ALU instruction.

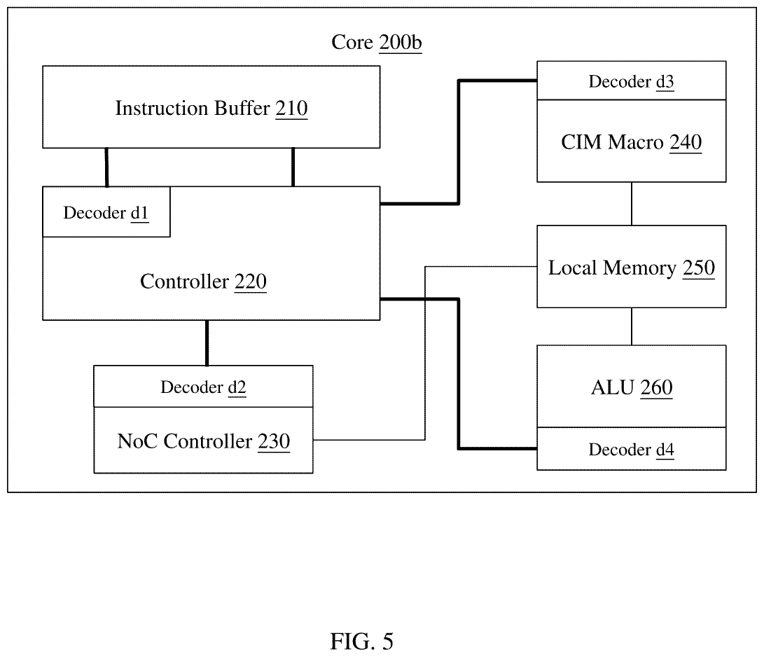

Reference is now made to FIG. 5. FIG. 5 is a schematic diagram of an example of a core 200b configured with respect to the core 200a and the core 200 corresponding to FIGS. 1-4, in accordance with various embodiments of the present disclosure. With respect to the embodiments of FIGS. 1-4, like elements in FIG. 5 are designated with the same reference numbers for ease of understanding.

The difference between the core 200a and the core 200b is that the decoder d2 of the core 200b is coupled between the controller 220 and the NoC controller 230, the decoder d3 of the core 200b is coupled between the controller 220 and the CIM macro 240, and the decoder d4 is coupled between the controller 220 and the ALU 260.

In the embodiments of FIG. 5, the portion I_1 is transferred from the instruction buffer 210 to the decoder d1. The portions I_2, I_3 and I_4 are transferred from the instruction buffer 210 to the controller 220.

In the cycle of the instruction I, The decoder d1 decodes the portion I_1 to generate the decoded controller instruction. The controller 220 performs operations according to the decoded controller instruction. In addition, the controller 220 transfers the portions I_2, I_3 and I_4 to the decoders d2-d4 respectively.

In the cycle of the instruction I, the decoders d2-d4 decode the portions I_2, I_3 and I_4 to generate the decoded NoC controller instruction, the decoded CIM macro instruction and the decoded ALU instruction. Then, the NoC controller 230, the CIM macro 240 and the ALU 260 perform operations according to the decoded NoC controller instruction, the decoded CIM macro instruction and the decoded ALU instruction respectively.

In some embodiments, the field of portions of the instruction includes multiple sub-fields. For example, as shown in the following Table. 1, the CIM macro field is separated into sub-fields of “operation”, “datatype”, “MM size”, “CIM output”, “with macro arithmetic ops”, etc.

TABLE 1
CIM macro sub-fields

| | | | MM | | within macro |
|---|---|---|---|---|---|
| cycle | operation | datatype | size | CIM output | arithmetic ops |
| 1 | XIN <= LM[R1] | INT8 | 32 | | |
| 2 | WIN <= LM[R2] | FP16 | | LM[R2] <= CIM_{—} | MaxExp(LM[R1]) |
| | | | | OUT | |
| . | | | | | |
| . | | | | | |
| . | | | | | |
| n | XIN <= LM[R1], | | 64 | | |
| | WIN <= LM[R2] | | | | |
| n + 1 | MAC | mixed | 16 | | |

Specifically, the “operation” indicates the CIM operation to be performed by the CIM macro 240 in the cycle. The “datatype” indicates the datatype of the data corresponding to the CIM operation. The “MM size” indicates the matrix multiplication size of the CIM operation. The “CIM output” indicates the CIM output operation in the cycle. The “within macro arithmetic ops” indicates some arithmetic operations performed by the CIM macro 240 in the cycle.

The CIM macro 240 performs operations of the sub-fields (e.g., operation, CIM output and within macro arithmetic ops) in parallel in each cycle.

For example, the CIM macro 240 performs operations according to the CIM sub-fields in first to “n+1”th cycles as shown in Table. 1. Specifically, in the first cycle, the CIM macro 240 performs a data load operation “XIN<=LM[R1]”. In the data load operation “XIN<=LM[R1]”, the CIM macro 240 loads data corresponding to an address R1 from the local memory 250 as the input of the CIM macro 240. The datatype of the input is set as eight-bit integer (INT8). The matrix multiplication size (i.e., the size of the CIM input) is set as 32×32.

In the first cycle, the CIM macro 240 performs an output operation “LM[R2]<=CIM_OUT”. In the output operation “LM[R2]<=CIM_OUT”, the CIM macro 240 sends its output to memory cells corresponding to an address R2 in the local memory 250. In addition, the CIM macro 240 performs operation “MaxExp(LM[R1])” to determine the maximum exponent of data corresponding to the address R1 in the local memory 250.

In the second cycle, the CIM macro 240 performs a data load operation “WIN<=LM[R2]”. In the data load operation “WIN<=LM[R2]”, the CIM macro 240 loads data corresponding to an address R2 from the local memory 250 as the weight of the CIM macro 240. The datatype of the weight is set as sixteen-bit floating point (FP16).

In the “n”th cycle, the CIM macro 240 performs a data load operation “XIN<=LM[R1], WIN<=LM[R2]”. In this data load operation, the CIM macro 240 loads data corresponding to an address R1 from the local memory 250 as the input of the CIM macro 240. The CIM macro 240 loads data corresponding to an address R2 from the local memory 250 as the weight of the CIM macro 240. The matrix multiplication size (i.e., the size of the CIM input and weight) is set as 64×64.

In the “n+1”th cycle, the CIM macro 240 performs an MAC operation. In the MAC operation, the CIM macro 240 performs MAC between the input and the weight of the CIM macro 240. The datatype are set as “mixed”. For example, the weight is set as integer and the input is set as floating point. The matrix multiplication size (i.e., the size of the CIM input and weight) is set as 16×16.

According to various embodiments, the system 10 supports mixed datatypes (number formats) for operations and on-chip datatype conversion. Specifically, the VLIW ISA of the system 10 supports multiple datatypes for operations. The datatypes include but not limit to floating point, brain floating point, per-vector scaled quantization (VSQ), microscaling (MX) data format, etc. The following Table 2 and 3 show examples of multiple datatype instructions.

Table. 2 shows an example of a CIM macro portion of an instruction supporting multiple datatypes.

TABLE 2
CIM macro sub-fields with mixed datatypes

| Operation | XIN datatype | WIN datatype | pSum datatype |
|---|---|---|---|
| MAC | INT8 | FP16 | FP8 |

Specifically, as shown in Table 2, the CIM sub-field of datatype is further separated into sub-fields of datatypes for input, weight, partial sum, etc. of the machine learning model. The “XIN datatype” denotes the datatype of the input. The “WIN datatype” denotes the datatype of the weight. The “pSum datatype” denotes the datatype of the partial sum generated by the MAC operation.

For example, the portion I_3 corresponding to the CIM macro field shown in FIG. 3 includes portions corresponding to the “XIN datatype”, “WIN datatype” and “pSum datatype” for setting the datatypes of inputs, weights and outputs of a CIM operation. For example, the portion I_3 may correspond to a MAC operation and the datatype of the input is set as eight-bit integer (INT8), the datatype of the weight is set as sixteen-bit floating point (FP16) and the datatype of the partial sum is set as eight-bit floating point (FP8). Then, the CIM macro 240 performs operations according to the portion I_3 with this mixed datatype configuration.

Table. 3 shows an example of an ALU portion of an instruction supporting multiple datatypes.

TABLE 3
ALU sub-fields with mixed datatypes

| Operation | IN datatype | OUT datatype |
|---|---|---|
| Exp(LM(R1)) | INT8 | FP16 |
| ChangeType(LM(R1)) | FP16 | FP8 |

Specifically, in the example of Table. 3, the “IN datatype” denotes the datatype of the input of an ALU operation. The “OUT datatype” denotes the datatype of the output of the ALU operation. The “Exp(LM(R1))” denotes an exponential operation to data corresponding to an address R1 in the local memory 250. The “Changetype(LM(R1))” denotes a datatype conversion operation to data corresponding to the address R1 in the local memory 250.

For example, the portion I_4 corresponding to the ALU field shown in FIG. 3 includes portions corresponding to the “IN datatype” and “OUT datatype” for setting the datatypes of inputs and outputs of an ALU operation. For example, the portion I_4 may correspond to an exponential operation and the datatype of the input is set as INT8 and the datatype of the output is set as FP16. The ALU 260 performs the exponential operation with the INT8 input and generates the FP16 output according to the portion I_4.

The portion I_4 may correspond to a datatype conversion operation and the datatype of the input is set as FP16 and the datatype of the output is set as FP8. The ALU 260 performs the datatype conversion operation to change the data corresponding to the address R1 from FP16 to FP8 according to the portion I_4.

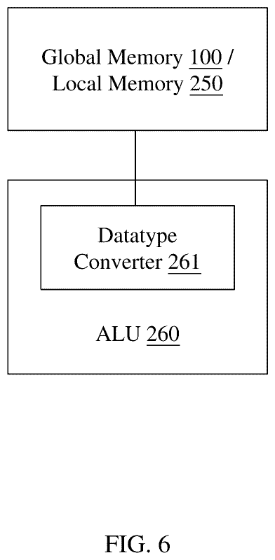

Reference is now made to FIG. 6. FIG. 6 is a schematic diagram of an example of the global memory 100, local memory 250 and the ALU 260 of the cores 200a, 200b and 200 corresponding to FIGS. 1-5, in accordance with various embodiments of the present disclosure. With respect to the embodiments of FIGS. 1-5, like elements in FIG. 6 are designated with the same reference numbers for ease of understanding.

As shown in FIG. 6, in some embodiments, the ALU 260 includes a datatype converter 261 to support multiple datatypes for operations as described above. The datatype converter 261 is coupled to the global memory 100 and/or the local memory 250. The datatype converter 261 receives data from the global memory 100 and/or the local memory 250. The datatype converter 261 transforms the data from a first datatype (e.g., integer) to a second datatype (e.g., floating point). Then, the datatype converter 261 outputs the transformed data with the second datatype to the global memory 100 and/or the local memory 250 for storage.

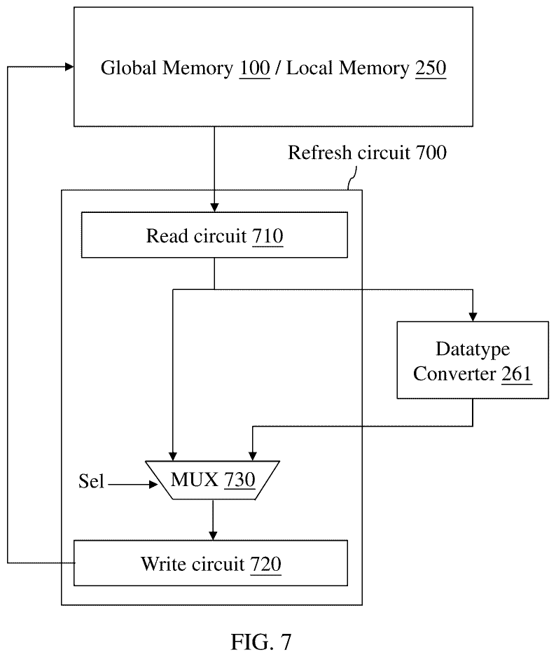

Reference is now made to FIG. 7. FIG. 7 is a schematic diagram of an example of a refresh circuit 700 of the system 10 corresponding to FIGS. 1-6, in accordance with various embodiments of the present disclosure. With respect to the embodiments of FIGS. 1-6, like elements in FIG. 7 are designated with the same reference numbers for ease of understanding.

In some embodiments, the system 10 further includes a refresh circuit 700. The refresh circuit 700 is coupled to the global memory 100 and/or the local memory 250. For illustration, the refresh circuit 700 includes a read circuit 710, a write circuit 720 and a multiplexer (MUX) 730. The read circuit 710 is coupled to the multiplexer 730, datatype converter 261, the global memory 100 and/or the local memory 250. The datatype converter 261 is further coupled to the multiplexer 730. The write circuit is coupled to the multiplexer 730 and the global memory 100 and/or the local memory 250.

The refresh circuit 700 performs refresh operation to the global memory 100 and/or the local memory 250. For example, in a refresh operation, the read circuit 710 retrieves data from the global memory 100 or the local memory 250 corresponding to a memory address. Then, the write circuit 720 rewrites the data to the global memory 100 or the local memory 250 corresponding to the memory address for the purpose of preserving the information.

According to various embodiments, the refresh circuit 700 dynamically changes the datatype of data stored in the global memory 100 or the local memory 250 to improve performance of the system 10 in some conditions with low power availability (e.g., the system 10 being a battery-operated SoC).

For example, in a refresh operation, the datatype converter 261 changes the datatype of the read data from the read circuit 710 to generate converted data. The multiplexer 730 selects between the converted data and the original read data to send to the write circuit 720 for rewriting according to a signal Sel. In some embodiments, the multiplexer 730 selects the converted data from the datatype converter 261 to output in response to the signal Sel having a first value (e.g., logic one). The multiplexer 730 selects the read data from the read circuit 710 to output in response to the signal Sel having a second value (e.g., logic zero) different from the first value.

In an example of the refresh circuit 700 performing refresh operation to a memory of gain cell, the refresh circuit 700 refreshes gain cell row with converted data from the datatype converter 261 with new datatype while refresh the memory.

In an example of the refresh circuit 700 performing refresh operation to a memory of RRAM, the refresh circuit 700 re-programming the memory with converted data from the datatype converter 261 with new datatype while resistance drift of the memory occurs.

An example of an ALU portion of an instruction corresponding to the refresh operation is shown in the following Table 4.

TABLE 4
ALU sub-fields corresponding to refresh operation

| Operation | IN datatype | OUT datatype |
|---|---|---|
| Mem Refresh | FP8 | INT8 |

Specifically, in the example of Table. X, the “Mem Refresh” denotes a refresh operation of the global memory 100 or the local memory 250. The “IN datatype” denotes the datatype of the data in the global memory 100 or the local memory 250 to be refreshed. The “OUT datatype” denotes the datatype of the data after the refresh operation.

For example, the portion I_4 corresponding to the ALU macro field shown in FIG. 3 includes portions corresponding to the “IN datatype” and “OUT datatype” for setting the datatypes of inputs and outputs of the refresh operation. For example, the portion I_4 may correspond to a refresh operation in which the current data is FP8 and the datatype of the refreshed data is INT8. The refresh circuit 700 and the datatype converter refresh the data from FP8 to INT8 according to the portion I_4. According to some embodiments, the refreshing of FP8 to INT8 helps reduces power consumption.

The configurations of FIGS. 1-7 are given for illustrative purposes. Various implements are within the contemplated scope of the present disclosure. For example, in some embodiments, the portions I_1, I_2, I_3 and I_4 are arranged in different order. For example, the portion I_1 corresponding to the ALU 260 may be the first “k−j” bits in the instruction I. In some embodiments, the refresh circuit 700 is included in the ALU 260.

In some approaches with instruction-level parallelism (i.e., performing different operations in one clock cycle), multiple instructions are read in a clock cycle and executed simultaneously if they are not conflicting. Therefore, in these approaches, the clock cycle for execution of each operation depends on previous operations. In other words, the exact clock cycle for each operation in these approaches is unknown before execution.

Compared with these approaches, the VLIW ISA of the system 10 also provide instruction-level parallelism but the exact clock cycle to perform each operation (i.e., the clock cycle to execute each instruction) is scheduled before execution. In some embodiments, the number (order) of clock cycle for executing an instruction is equal to the number of the instruction stored in the instruction buffer 210. For example, the first instruction stored in the first row of the instruction buffer 210 is executed in the first clock cycle. The instruction-level parallelism with such configuration of the system 10 benefits execution of instructions like gain cell refresh operations or RRAM resistance drift check operation which need to be scheduled exactly.

For example, as shown in Table 5, the first to seventh instructions stored in the instruction buffer 210 is performed in the first to seventh clock cycle.

TABLE 5
instructions scheduled to perform in exact clock cycles

| cycle | instruction | CIM operation | NoC operation |
|---|---|---|---|
| 1 | I1 | W <= GC[0] | NOP |
| 2 | I2 | NOP | LM[0] <= GM[0] |
| 3 | I3 | IN <= LM[0] | NOP |
| 4 | I4 | MAC | LM[1] <= GM[1] |
| 5 | I5 | IN <= LM[1] | NOP |
| 6 | I6 | MAC | NOP |
| 7 | I7 | Refresh | NOP |

As shown in Table. 5, when operations corresponding to different fields (e.g., CIM operations and NoC operations) conflict, these operations are performed in different cycles. In some embodiments, some operations corresponding some fields are set as “NOP” (i.e., no operation) to avoid conflict in the same clock cycle.

For example, in the first clock cycle, the instruction I1 is executed. The CIM macro field of the instruction I1 indicates the CIM operation of “W<=GC[0]”. In the CIM operation of “W<=GC[0]”, data in the gain cell corresponding to the address “0” of CIM array in the CIM macro 240 is loaded as weight. The NoC controller field of the instruction I1 indicates the NoC operation being “NOP”.

For example, to schedule the refresh operation performed in the seventh clock cycle. The instruction indicating the refresh operation is set as the seventh instruction 17 in the instruction buffer 210.

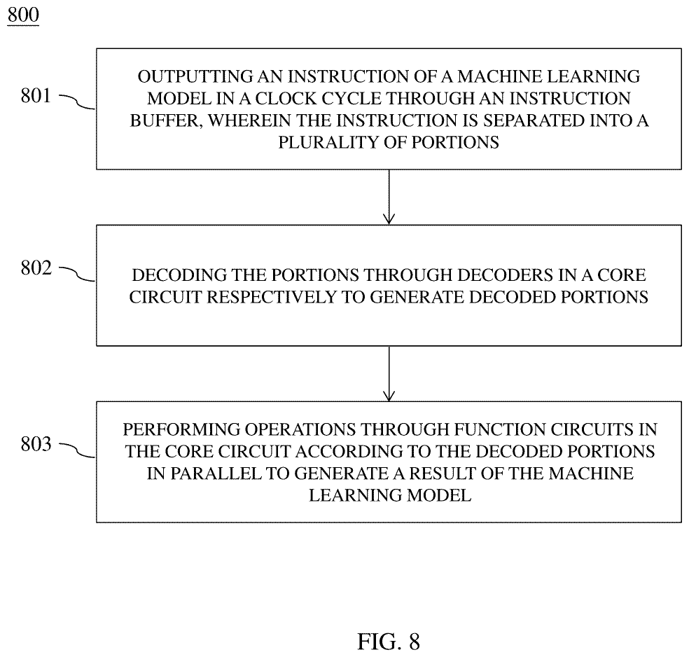

Reference is now made to FIG. 8. FIG. 8 is a flowchart diagram of a method 800 for operating the system 10, cores 200, 200a, 200b corresponding to FIGS. 1-7, in accordance with some embodiments of the present disclosure. It is understood that additional steps can be provided before, during, and after the steps shown by FIG. 8, and some of the steps described below can be replaced or eliminated, for additional embodiments of the method. The order of the steps may be interchangeable. Some of the steps are performed concurrently. Throughout the various views and illustrative embodiments, like annotations and reference numbers are used to designate like elements. The method 800 includes steps s1-s3 that are described below with reference to the system 10, cores 200, 200a, 200b corresponding to FIGS. 1-7.

In step 801, the instruction buffer 210 outputs an instruction of the machine learning model in a clock cycle. The instruction I is separated into portions corresponding to different fields (e.g., portions I_1, I_2, I_3 and I_4).

In step 802, multiple decoders decode the portions through respectively to generate multiple decoded portions. For example, the decoder d1-d4 decode the portions I_1, I_2, I_3 and I_4 respectively to generate decode portions as the decoded controller instruction, the decoded NoC controller instruction, the decoded CIM macro instruction and the decoded ALU instruction.

In step 803, the function circuits (e.g., the controller 220, the NoC controller 230, the CIM macro 240 and the ALU 260) perform operations according to the decode portions in parallel to generate a result of the machine learning model.

In some embodiments, a first portion of the portions includes first and second sub-field indicating a first datatype (e.g., integer) and a second datatype (e.g., floating point). A function circuit (e.g., ALU 260) changes data in a memory (e.g., the local memory 250 or the global memory 100) from the first datatype to the second datatype according to the first portion.

In some embodiments, the controller 220 transfers the decoded portions to the function circuits like the NoC controller 230, the CIM macro 240 and the ALU 260.

In summary, a system and method for AI acceleration are provided. The system and method support the VLIW based ISA, in which instructions are separated into fields corresponding different function circuits in a core of the system. The configurations of the VLIW based ISA allow the system to update some workload-specific instruction (e.g., matrix multiplication size) and/or hardware like CIM macro without modifying the other portion of the system. As a result, the design time for test or prototyping the system can be reduced by eliminating the time to re-design, re-verification the whole system while updating. In addition, the VLIW based ISA supports exact scheduling of instructions which helps perform operations like memory refresh and RRAM resistance drift check correctly.

In some embodiments, a system is provided. The system comprises a global memory and multiple core circuits. The global memory stores data of a machine learning model. The core circuits are coupled to the global memory, in which each of the core circuits comprises an instruction buffer, a compute-in-memory (CIM) circuit and a controller. The instruction buffer stores a first instruction including portions corresponding to different fields. The CIM circuit configured to perform CIM operations according to a first portion of the portions. The controller is coupled between the instruction buffer and the CIM circuit, in which the controller operates according to a second portion of the portions. The CIM circuit and the controller cooperate to perform operations of the machine learning model.

In some embodiments, a system is provided. The system comprises a global memory and multiple core circuits. The global memory stores data of a machine learning model. The core circuits are coupled to the global memory. Each of the core circuits comprises an instruction buffer and multiple function circuits. The instruction buffer outputs an instruction of the machine learning model in each clock cycle. The instruction is separated into a plurality of portions. Each of the function circuits corresponds to one of the portions, in which the function circuits perform operations according to the portions simultaneously to generate a result of the machine learning model.

In some embodiments, a method is provided. The method comprises: outputting an instruction of a machine learning model in a clock cycle through an instruction buffer, in which the instruction is separated into multiple portions; decoding the portions through multiple decoders in a core circuit respectively to generate a plurality of decoded portions; and performing operations through a plurality of function circuits in the core circuit according to the plurality of decoded portions in parallel to generate a result of the machine learning model.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a global memory configured to store data of a machine learning model; and
a plurality of core circuits coupled to the global memory, wherein each of the core circuits comprises:
an instruction buffer configured to store a first instruction including a plurality of portions corresponding to different fields;
a compute-in-memory (CIM) circuit configured to perform CIM operations according to a first portion of the portions; and
a controller coupled between the instruction buffer and the CIM circuit, wherein the controller is configured to operate according to a second portion of the portions,
wherein the CIM circuit and the controller cooperate to perform operations of the machine learning model.

2. The system of claim 1, wherein each of the core circuits further comprises:
a network on chip (NoC) controller coupled to the controller, wherein the NoC controller is further coupled to an adjacent NoC controller in an adjacent core circuit for communication,
wherein the NoC controller performs the communication according to a third portion of the portions.

3. The system of claim 2, wherein the NoC controller is further coupled to the global memory to transfer data between each of the core circuits and the global memory.

4. The system of claim 2, wherein each of the core circuits further comprises:
a local memory coupled to the CIM circuit and the NoC controller, wherein the CIM circuit and the NoC controller are configured to transfer data through the local memory.

5. The system of claim 4, wherein each of the core circuits further comprises:
an arithmetic logic unit (ALU) coupled to the local memory, wherein the ALU is configured to perform a computation of data stored in the local memory,
wherein the ALU performs the computation according to a fourth portion of the portions.

6. The system of claim 1, wherein the instruction buffer is configured to output each instruction stored the instruction buffer in a cycle separately,
wherein each of the core circuits further comprises function circuits corresponding to the portions respectively,
wherein the function circuits perform operations according to the portions in parallel in the cycle,
wherein the function circuits include the CIM circuit and the controller.

7. The system of claim 6, wherein each of the core circuits further comprises:
a plurality of decoders coupled between the instruction buffer and the controller, wherein the decoders are configured to decode the portions respectively to generate decoded portions,
wherein the controller transfers each of the decoded portions to a corresponding one of the function circuits to perform the operations of the machine learning model.

8. The system of claim 1, wherein the each of the core circuits further comprises:
a first decoder coupled between the controller and the CIM circuit, wherein the first decoder is configured to decode the first portion and generate a first decode portion to command the CIM circuit; and
a second decoder coupled between the instruction buffer and the controller, wherein the second decoder is configured to decode the second portion and generate a second decode portion to command the controller.

9. A system, comprising:
a global memory configured to store data of a machine learning model; and
a plurality of core circuits coupled to the global memory, wherein each of the core circuits comprises:
an instruction buffer configured to output an instruction of the machine learning model in each clock cycle, wherein the instruction is separated into a plurality of portions; and
a plurality of function circuits, wherein each of the function circuits corresponds to one of the portions,
wherein the function circuits are configured to perform operations according to the portions simultaneously to generate a result of the machine learning model.

10. The system of claim 9, wherein the function circuits include:
a compute-in-memory (CIM) circuit configured to perform CIM operations according to a first portion of the portions;
a network on chip (NoC) controller configured to perform communication between the core circuits according to a second portion of the portions;
an arithmetic logic unit (ALU) configured to perform arithmetic computations according to a third portion of the portions; and
a controller coupled between the instruction buffer and the CIM circuit, the NoC controller and the ALU to transfer the first to third portions.

11. The system of claim 10, wherein each of the core circuits comprises:
a first decoder coupled between the controller and the CIM circuit, wherein the first decoder is configured to decode the first portion to command the CIM circuit;
a second decoder coupled between the controller and the NoC controller, wherein the second decoder is configured to decode the second portion to command the NoC controller; and
a third decoder coupled between the controller and the ALU, wherein the third decoder is configured to decode the third portion to command the ALU.

12. The system of claim 10, wherein each of the core circuits further comprises:
a local memory configured to store data from the global memory through the NoC controller, wherein the ALU comprises a datatype converter coupled to the local memory,
wherein the datatype converter is configured to change datatype of the data in the local memory according to the third portion.

13. The system of claim 12, wherein each of the core circuits further comprises:
a refresh circuit comprising:
a read circuit configured to read data from the local memory, wherein the datatype converter is coupled to the read circuit to change datatype of the data read by the read circuit;
a multiplexer coupled to the read circuit and the datatype converter, wherein the multiplexer is configured to select the data from the read circuit and a converted data from the datatype converter to output; and
a write circuit configured to receive output data from the multiplexer and write the output data to the local memory.

14. The system of claim 9, wherein each of the core circuits further comprises:
a controller; and
a plurality of decoders coupled between the instruction buffer and the controller, wherein the decoders are configured to decode the portions respectively to generate a plurality of decoded portions,
wherein the controller is configured to transfer the decoded portions to the function circuits to command the function circuits.

15. The system of claim 14, wherein the decoders are coupled to the instruction buffer through a plurality of metal lines,
wherein the instruction buffer outputs each bit of the instruction through a corresponding one of the metal lines simultaneously in a clock cycle.

16. The system of claim 9, wherein a first portion of the portions includes a first datatype and a second datatype,
wherein a first function circuit of the function circuits receive an input having the first datatype and generate an output having the second datatype according to the first portion.

17. The system of claim 9, wherein the function circuits include a CIM circuit, wherein the a first portion of the portions corresponds to the CIM circuit,
wherein the first portion includes sub-fields indicating different CIM operations,
wherein the CIM circuit is configured to perform the different CIM operations in a same clock cycle according to the first portion.

18. A method, comprising:
outputting an instruction of a machine learning model in a clock cycle through an instruction buffer, wherein the instruction is separated into a plurality of portions;
decoding the portions through a plurality of decoders in a core circuit respectively to generate a plurality of decoded portions; and
performing operations through a plurality of function circuits in the core circuit according to the plurality of decoded portions in parallel to generate a result of the machine learning model.

19. The method of claim 18, wherein a first portion of the portions includes first and second sub-field indicating a first datatype and a second datatype,
wherein performing the operations comprises:
changing data in a memory from the first datatype to the second datatype according to the first portion.

20. The method of claim 18, further comprising:
transferring the decoded portions to the function circuits through a controller in the core circuit.
